(19) United States
(12) Patent Application Publication
(10) Pub. No.: US 2025/0271279 A1
(43) Pub. Date: Aug. 28, 2025

(54) Method For Creating A Digital Map Of Surroundings Of A Vehicle By Means Of A Mapping System, And Mapping System

(71) Applicant: Volkswagen Aktiengesellschaft, Wolfsburg (DE)

(72) Inventors: Stefan Wappler, Söllingen (DE); Niklas Koch, Tappenbeck (DE); Roland Kube, Schwülper (DE)

(73) Assignee: Volkswagen Aktiengesellschaft, Wolfsburg (DE)

(21) Appl. No.: 19/057,406

(22) Filed: Feb. 19, 2025

(30) Foreign Application Priority Data
Feb. 23, 2024 (DE) 10 2024 201 714.0

(51) Int. Cl. G01C 21/00

(52) U.S. Cl. CPC G01C 21/387; G01C 21/3811; G01C 21/3815

(57) ABSTRACT

A method for creating a digital map of surroundings of a vehicle, comprising: providing a basic factor graph, comprising nodes and factors that were created on the basis of single-trip data from a previous trip; providing further single-trip data relating to a further trip of a vehicle that is different from the previous trip; extending the basic factor graph by generating further nodes and further factors and inserting the further nodes and further factors into the basic factor graph on the basis of the provided further single-trip data, such that an extended factor graph is generated by extending the basic factor graph; identifying nodes of the further nodes which have changed by more than a specified deviation in comparison to the nodes of the provided basic factor graph; and creating a digital map on the basis of the extended factor graph in consideration of the identified nodes.

### CROSS-REFERENCE TO RELATED APPLICATIONS

This application claims priority to German Patent Application DE 10 2024 201 714.0, filed on Feb. 23, 2024 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a method of creating a digital map of surroundings of a vehicle using a mapping system. The disclosure further relates to a mapping system.

Graph-based SLAM methods are known to the inventors, which generate a factor graph and then a digital map from the factor graph. The generated digital map can be inaccurate.

### SUMMARY

A need exists to provide or update a digital map in an improved manner. The need is addressed by the subject matter of the independent claim(s). Embodiments of the invention are described in the dependent claims, the following description, and the drawings.

### BRIEF DESCRIPTION OF THE DRAWINGS

FIG. 1 shows an example embodiment of a mapping system according to the teachings herein; and

FIG. 2 shows an example embodiment of a factor graph.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

Some embodiments relate to a method for creating a digital map of surroundings of a vehicle by means of a mapping system. In particular, the method comprises the following steps:
in particular, providing a basic factor graph, comprising nodes and factors generated on the basis of single-trip data from a previous trip;
in particular, providing further single-trip data relating to a further trip of a vehicle that is different from the previous trip;
in particular, extending the basic factor graph by generating further nodes and further factors and inserting the further nodes and further factors into the basic factor graph on the basis of the provided further single-trip data, such that an extended factor graph is generated by extending the basic factor graph;
in particular, identifying nodes of the further nodes which have changed by more than a specified deviation in comparison to the nodes of the provided basic factor graph;
in particular, creating a digital map on the basis of the extended factor graph in consideration of the identified nodes.

This method makes it possible to create a digital map in an improved manner. For example, an improved digital map can be created. By extending the basic factor graph and by creating the digital map, which for example only takes place thereafter, changes, for example, can be incorporated better into the created digital map. This is particularly beneficial in comparison to methods which merely compare maps that have already been created. By means of the method, data of the basic factor graph can be used to generate the digital map, even if some of the data are obsolete. In particular, structural changes in the surroundings of the vehicle, for example in a parking garage, are taken into account by means of the method.

In some embodiments, the method is a computer-implemented method. For example, the basic factor graph and the further single-trip data are provided to an evaluation circuit and the evaluation circuit carries out the subsequent steps of the method. For example, the evaluation circuit provides the generated digital map to further vehicles.

In the context of this discussion, the terms ‘evaluation circuit’, ‘controller’, and ‘processor’ are understood broadly to comprise hardware and hardware/software combinations to provide the respectively discussed functionality. The respective processor′, ‘controller’, and/or ‘evaluation circuit’ may be formed integrally with each other and/or with further components. For instance, the functionality of the processor′, ‘controller’, and/or ‘evaluation circuit’ may be provided by a microprocessor, microcontroller, FPGA, or the like, with corresponding programming. The programming may be provided as software or firmware, stored in a memory, or may be provided at least in part by dedicated (‘hard-wired’) circuitry.

For example, the method may be carried out for multiple trips. The multiple trips are carried out, for example, by the same vehicle or by various vehicles. For example, fleet data of a vehicle fleet are thus also used. This includes multiple trips of a vehicle as fleet data as well as individual trips of various vehicles as fleet data. The single-trip data may, for example, also be referred to as a maplet or data packet. For example, exactly one data packet is recorded per trip. However, it is also possible for a data packet to relate to multiple further trips of a vehicle. A data packet comprises, for example, ego motion data and mapping object observations. The ego motion data comprise, for example, multiple items of position data of the vehicle, for example a spatial coordinate and, if applicable, an orientation of the vehicle in space. The generated map is, in particular, a global map. For example, the spatial coordinate relates to a global origin of the digital map.

In particular, the steps do not need to be performed in any particular order and they may overlap, in particular at least in part. The method may be carried out, for example, as a so-called offline SLAM (simultaneous localization and mapping) method. This means that in some embodiments, the map is created only after the end of the further trip in terms of time. For example, the digital map is created for a parking garage and/or a parking facility having multiple parking zones, for example the digital map represents the parking garage and/or parking facility.

The digital map can be understood to be a dataset that places objects in a specified spatial region in relation to one another and/or in relation to a predefined reference point or else coordinate origin. In some embodiments, the digital map may contain semantic information relating to the objects.

In some embodiments, the method can be referred to as graph-based SLAM. It is possible for there to be a vehicle fleet that collects environment data using vehicle sensors and generates so-called maplets therefrom while said vehicle fleet travels through relevant parking areas. A maplet is, for example, a data container which contains the ego motion of the vehicle, which is, for example, a fleet vehicle of the vehicle fleet, as well as mapping object observations from the surroundings of the vehicle relative to an observer position of the vehicle. Mapping objects may be walls, columns, posts, another, in particular parking, vehicle, ground surfaces, free spaces, markings, and/or parking spaces. These objects are formed, for example, in the vehicle from the sensor data, for example radar, camera, ultrasonic sensors, and/or lidars, and combined into a maplet by means of a vehicle component. Depending on the availability of a communication interface, a maplet is, if applicable, transmitted to a central evaluation circuit, in particular uploaded to or temporarily stored in a backend component (cloud) or transmitted to another entity for uploading, for example via ad hoc WLAN or else C2X. In particular, the backend component receives maplets of individual fleet vehicles over time. The method according to the teachings herein relates, for example, to a computer-implemented method that generates a global map, in particular, from the maplets. For example, an item of information as to the point in time to which a node is to be assigned is processed for each node in the extended factor graph. Based on this information, an analysis is carried out, if applicable, which identifies which nodes were removed over time, which nodes have re-emerged, and which node has changed. A node is, for example, identified as having been removed if a corresponding mapping object was removed in the parking area. A node is, for example, identified as having emerged if a corresponding mapping object was inserted in the parking area, for example if a new parking space is provided by painting a new marking on the ground.

In some embodiments, the provided basic factor graph comprises ego position nodes and landmark nodes of detected landmarks in the surroundings of the vehicle as nodes. The provided basic factor graph comprises, in particular, landmark factors and ego position factors as factors. The ego position nodes represent, for example, positions to which a vehicle, in particular the vehicle, has traveled. The landmark nodes represent, for example, landmarks that have been traveled to and, for example, detected. The ego position factors for example indicate a spatial relationship between ego position nodes. The landmark factors for example indicate a spatial relationship between ego position nodes and landmark nodes. The spatial relationships are given, for example, in meters.

It is possible for the further nodes to be further landmark nodes and further ego position nodes and for the further factors to be further landmark factors and further ego position factors in some embodiments.

For example, the further ego position nodes are generated based on the ego motion data of the single-trip data. If applicable, the further landmark nodes are generated based on the mapping object observations. Landmarks are, for example, mapping objects in the surroundings of the vehicle which are detected, for example, by means of a detection system of the mapping system, in particular of the vehicle. Thus, information about the ego positions of the vehicle and about the positions of the mapping objects can be recorded.

A landmark or a mapping object can be understood to mean features and/or patterns in surroundings that can be identified and to which at least one item of location information or position information can be assigned. These may, for example, be characteristic points or objects that are arranged at particular positions in the surroundings. A landmark type can be assigned to a landmark, in particular based on one or more geometric and/or semantic properties of the landmark. For example, road markings, lane markings, other ground marking lines, building edges or corners, masts, posts, road signs, warning signs or other signs, elements of vegetation, structures or parts thereof, parts of traffic control systems, two-dimensional codes may be defined in each case as landmark types. A landmark may also be assigned to multiple landmark types.

In some embodiments, landmark nodes of the further nodes are compared with landmark nodes of the nodes of the provided basic factor graph in order to identify the nodes.

Here, it is in particular not necessary to compare the ego position nodes and the further ego position nodes. As a result, the method can be carried out more quickly and, in some embodiments, more efficiently.

For example, a distance between one of the landmark nodes and the further landmark nodes is determined in each case. If the determined distance is, for example, less than or equal to a specified maximum value, the landmark nodes to be compared are identified as matching. For example, the landmark nodes to be compared are identified as being different if they are below the specified maximum value. This allows for clear and quick identification.

The maximum value is, for example, a fixedly specified value, for example between 0 cm and 50 cm, in particular between 5 cm and 15 cm, in particular 10 cm. Optionally, the maximum value is specified depending on a sensor type of the detection system. The higher the accuracy of the sensor type with which the relevant landmark node was determined, the lower the maximum value. If applicable, further parameters are taken into account when determining the landmark nodes, for example the distance between the landmark and the vehicle, since this potentially influences the accuracy of the determined distance of the landmark and/or landmarks from one another. As a result, an accuracy of the sensor types used is taken into consideration. This makes it possible to implicitly enhance even ego motion data that are not qualitatively ideal.

In some embodiments, the maximum value is determined by means of a machine learning algorithm. For this purpose, the method is carried out multiple times, for example, and the extended factor graph is analyzed, in particular, after each time the method is carried out. Thus, if applicable, an order of magnitude of typical, for example average, deviations is determined. The maximum value is in some embodiments determined as a value that is, for example, 50%, 20%, or 10% larger than the determined typical deviation.

In some embodiments, a change detection algorithm is executed for identifying the nodes. The change detection algorithm determines distances between the landmark nodes and the further landmark nodes by means of the factors and the further factors. A benefit of these embodiments is that misassociations of mapping objects can be reduced. For example, the misassociations of the mapping objects are reduced compared to methods in which the mapping object observations are only assigned after the digital map has been created.

In some embodiments, the nodes and/or the further nodes are assessed depending on the determined distances. For example, the nodes and the further nodes, in particular the landmark nodes and the further landmark nodes, are deemed to be inserted, deleted, or shifted depending on the determined distances from one another.

If applicable, the change detection algorithm is executed for each further landmark node. Here, for example, the distances between all or only the surrounding landmark nodes of the basic factor graph and the relevant further landmark node are compared with the specified maximum value. Matching landmark nodes are optionally identified as having already been described. For example, it is possible that no matching landmark node of the basic factor graph is found for the relevant further landmark node. In this case, the relevant landmark node is deemed to be inserted, for example. However, it is also possible, in this case, to carry out a further comparison with a further maximum value that is higher than the maximum value. For example, in the case described, the further landmark node is only deemed to be inserted if all determined distances are greater than the specified further maximum value. If one, for example exactly one, of the determined distances lies between the maximum value and the further maximum value, for example the relevant landmark node of the basic factor graph and, in particular, also the relevant further landmark node are deemed to be shifted. This produces the benefit that all landmark nodes and thus all detected mapping objects are incorporated into the factor graph, in particular due to the fact that the change detection algorithm is executed, if applicable, for each further landmark node. As a result, an improved digital map can be created or else updated.

In some embodiments, the change detection algorithm can be executed as follows: For the SLAM method itself, the insertion or deletion of landmark nodes, which may, in particular, also be referred to as observation nodes, is in particular unproblematic over time. Even if observations of a mapping object from a certain point in time are no longer available in future maplets, this potentially does not interfere with the SLAM method. In particular, it is not a problem either if additional observations are made after a particular point in time. This may occur anyway, for example, even without structural changes to the parking area merely due to mapping objects being concealed, for example, by dynamic or static vehicles. The modification of a mapping object, in particular, is problematic: If, for example, a post is moved by a short distance within the parking area, the SLAM method would possibly yield a suboptimal global map without additional analysis, since the SLAM method would attempt to ascertain the best compromise from the ego positions and observations. The recognition of modified mapping objects can for example be implemented in such a way that similar mapping objects are systematically searched for in the environment of a mapping object within the factor graph by means of a neighborhood search. Shifted mapping objects can be identified using a temporal analysis of found modification candidates. The information generated in the process is taken into account, in particular, within the data association during execution of the SLAM method in such a way that it is ensured that changed observation nodes are not associated with one another.

In some embodiments, identified nodes are marked as inserted, deleted, or shifted.

As a result, it is possible to trace a history of the factor graph. In particular, the landmark nodes and the further landmark nodes are marked according to how they are assessed. For example, the extended factor graph becomes the basic factor graph when the method is carried out anew, in particular for further single-trip data. Thus, it is possible to establish, after each time the method is carried out and based on the landmark nodes and further landmark nodes, whether these landmark nodes have been inserted, deleted, or shifted or, in particular, are unchanged in each case.

For example, landmark nodes marked as deleted are not actually deleted from the factor graph. This makes it possible to utilize single-trip data from the previous trip to improve the digital map. For example, mapping objects corresponding to the landmark nodes marked as deleted are not shown in the digital map when the digital map is being created or updated.

In some embodiments, each node and each further node comprises a time stamp. As a result, a history of the factor graph can be tracked better.

For example, landmark nodes having the earlier time stamp are shown in the created or updated digital map as nodes that are marked as changed and, in particular, that represent the same mapping object.

In some embodiments, a road network is generated depending on the further single-trip data and inserted into the created or else updated map. As a result, the road network can be used for vehicles following on behind.

In some embodiments, a trajectory of the vehicle is recorded during the further trip. For example, the recorded trajectory is inserted in the digital map, in particular as a road network. The inserted road network is used, for example, to determine the trajectory of further trips, in particular at least semi-autonomous trips.

In some embodiments, a digital predecessor map is provided based on the provided basic factor graph. The digital predecessor map is updated on the basis of the extended factor graph in consideration of the identified nodes.

For example, an updated global map is created each further time the further single-trip data are provided. This produces the benefit that the global digital map is based on the latest available single-trip data.

It is also possible for the global digital map to only be created or updated after multiple further items of single-trip data have been provided and the basic factor graph has been extended by multiple further nodes and factors on the basis of the multiple further items of single-trip data. For example, a particular quantity of provided further single-trip data from which the digital map is updated is specified. It is also possible for the digital map to be updated or created if a specified quantity of marked nodes, in particular nodes marked as inserted, shifted, or deleted, is exceeded. As a result, it is possible, for example, to prevent the map from being updated unnecessarily.

In some embodiments, the created or else updated map is provided to a server apparatus that is external to the vehicle. For example, further vehicles receive the created or updated map from the server apparatus.

It is also possible for the created or updated digital map to be verified based on specified criteria before being provided to the server apparatus or before it can be received by further vehicles. The criteria relate, for example, to heuristic completeness rules. If it is established during the verification that, for example, at least one mapping object has a course, position, or orientation that is physically impossible or illogical, the created or updated map is not provided to the server apparatus or sent to the further vehicles, e.g., if the verification is carried out, for example, in the server.

In some embodiments, the updated digital map is compared with the digital predecessor map. The digital map is changed on the basis of this comparison. In this way, for example, mapping objects that have a course, position, or orientation that is physically impossible or illogical can be adapted. As a result, for example, inconsistencies in the generated or updated map are removed and the map is provided to the server and/or the further vehicles.

In some embodiments, for example after the provision of the further single-trip data, it is checked whether single-trip data from the previous trip have already been provided, e.g., for the relevant surroundings of the vehicle. If this is not the case, the basic factor graph is generated and the method is, for example, terminated. If corresponding single-trip data have already been provided, the further method steps are carried out.

Some embodiments relate to an electronic mapping system for creating a digital map. The mapping system comprises a detection system, a memory, and an evaluation circuit, wherein:
the evaluation circuit is configured to obtain a basic factor graph, comprising nodes and factors generated on the basis of single-trip data from a previous trip;
the detection system is configured to record further single-trip data relating to a further trip of a vehicle that is different from the previous trip and to provide said data to the evaluation circuit;
the evaluation circuit is configured to extend the basic factor graph by generating further nodes and further factors and inserting the further nodes and further factors into the basic factor graph on the basis of the provided further single-trip data, such that an extended factor graph is generated by extending the basic factor graph;
the evaluation circuit is configured to identify nodes of the further nodes which have changed by more than a specified deviation in comparison to the nodes of the provided basic factor graph;
the evaluation circuit is configured to create a digital map on the basis of the extended factor graph in consideration of the identified nodes.

For example, the vehicle comprises the detection system. If applicable, the detection system comprises a first detector for detecting mapping objects and a second detector for detecting an ego motion of the vehicle.

The first detector comprises, for example, one or more sensors for detecting surroundings of the vehicle. The first detector may, for example, be understood as a sensor system that is capable of generating sensor data or sensor signals that depict, represent, or reproduce surroundings of the vehicle. For example, the first detector may comprise cameras, radar systems, lidar systems, or ultrasonic sensor systems.

The second detector comprises, for example, one or more sensors for detecting a position and/or orientation of the vehicle. A GNSS system, for example, is used to detect the position of the vehicle. Pitch angles, yaw angles, and roll angles of the vehicle, for example, are detected, for example by means of a position sensor, in order to detect the orientation of the vehicle. Alternatively or additionally and in some embodiments, the second detector detects the position and/or orientation of the vehicle, for example, by means of odometry.

The evaluation circuit comprises, for example, one or more computing units (e.g., one or more processors). For example, an external server comprises the evaluation circuit. Alternatively or additionally and in some embodiments, it is possible for the vehicle to comprise the evaluation circuit. In particular, the external server comprises the memory.

In some embodiments, the ego motion data in the fleet vehicles are based on an extrapolation of a highly accurate global navigation satellite system (GNSS system) in the vehicles during travel in areas without GNSS reception. This can, for example, be referred to as “dead reckoning” by vehicle odometry. If applicable, the ego motion data has the same reference system per se and can be transferred directly into nodes of the factor graph.

In some embodiments, an additional step for adapting the ego motion data takes place, in particular if the vehicle does not have the GNSS system option. For example, a maplet can be placed in a global reference system by means of a radar-based or camera-based odometry system, for example radar odometry, visual odometry, radar localization, and/or visual localization. Alternatively or additionally and in some embodiments, the maplet may, if applicable, be oriented in an accordingly consistent manner by means of backend-side adjustment, for example using ICP (iterative closest point) or NDT (normal distribution transform).

Some embodiments relate to a mapping system. The mapping system is configured to carry out the method according to the teachings herein or a one or more embodiments thereof. In some embodiments, the mapping system executes the method.

Some embodiments relate to a vehicle that comprises a mapping system according to the teachings herein.

Some embodiments relate to a method for guiding a vehicle. Here, the vehicle is guided on the basis of a digital map that was created according to the method according to the teachings herein.

In the embodiments described herein, the described components of the embodiments each represent individual features that are to be considered independent of one another, in the combination as shown or described, and in combinations other than shown or described. In addition, the described embodiments can also be supplemented by features other than those described.

Reference will now be made to the drawings in which the various elements of embodiments will be given numerical designations and in which further embodiments will be discussed.

Specific references to components, process steps, and other elements are not intended to be limiting. Further, it is understood that like parts bear the same or similar reference numerals when referring to alternate FIGS. The FIGS. are schematic and not necessarily to scale.

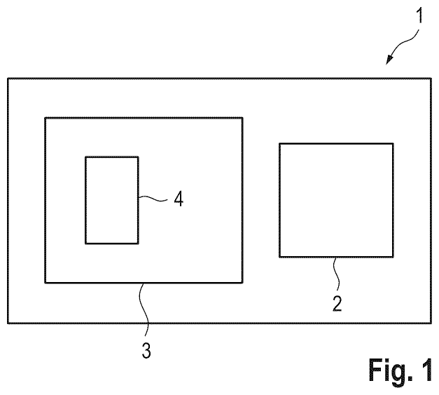

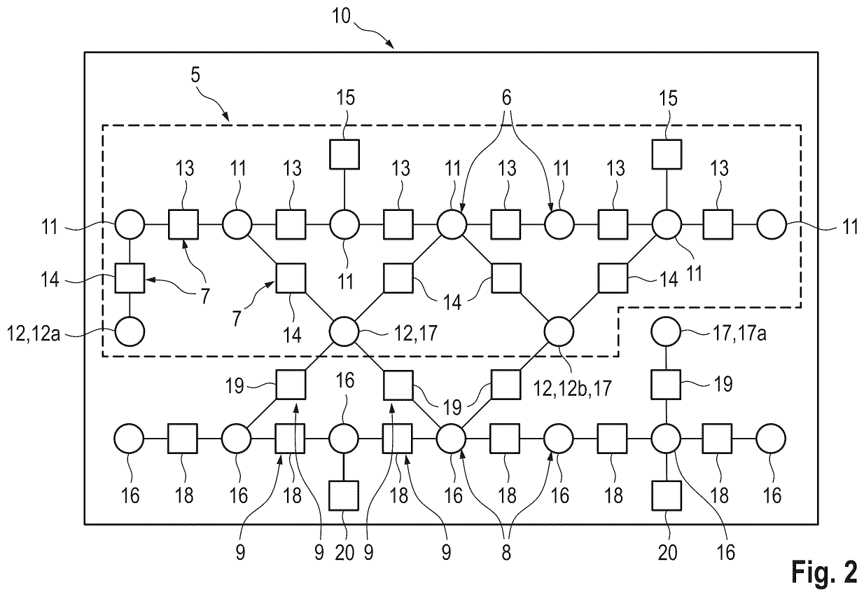

In FIG. 1, an embodiment of a mapping system 1 for creating a digital map is schematically represented. The mapping system 1 comprises a detection system 2, an evaluation circuit 3, and, if applicable, a memory 4. For example, the mapping system 1 is configured to execute the following:
providing a basic factor graph 5 (FIG. 2), comprising nodes 6 (FIG. 2) and factors 7 (FIG. 2) that were created on the basis of single-trip data from a previous trip;
providing further single-trip data relating to a further trip of the vehicle that is different from the previous trip;
extending the basic factor graph 5 by generating further nodes 8 (FIG. 2) and further factors 9 (FIG. 2) and inserting the further nodes 8 and further factors 9 into the basic factor graph 5 on the basis of the provided further single-trip data, such that an extended factor graph 10 (FIG. 2) is generated by extending the basic factor graph 5;
identifying nodes of the further nodes 8 which have changed by more than a specified deviation in comparison to the nodes 6 of the provided basic factor graph 5;
creating a digital map on the basis of the extended factor graph 10 in consideration of the identified nodes.

For example, a first vehicle carries out a first trip in a parking garage, for example. For example, the first vehicle comprises a detection system 2 for recording the single-trip data. The single-trip data comprise, in particular, ego motion data of the vehicle and mapping objects, which can also be referred to as landmarks. The ego motion data of the vehicle comprise, in particular, positions and orientations of the vehicle. If applicable, the detection system 2 repeats the detection between 0.5 milliseconds and 1 second, in particular every millisecond.

For example, the single-trip data are provided to the evaluation circuit 3. In particular, the evaluation circuit 3 checks whether single-trip data are already available for the relevant location, in particular the parking garage. If this is not the case, a basic factor graph 5, in particular, is generated from the provided single-trip data. For example, the digital map is created based on the basic factor graph 5 in this case. If single-trip data are already available, the provided single-trip data are, in particular, further single-trip data and the basic factor graph 5 is extended accordingly to produce the factor graph 10. If a digital map has already been created, it is for example updated in consideration of the extended factor graph 10. If no digital map has been created yet, it is created in consideration of the extended factor graph 10.

FIG. 2 shows a schematic embodiment of an extended factor graph 10, in particular after the method for creating the digital map has been carried out. The extended factor graph 10 comprises the basic factor graph 5, for example. The basic factor graph 5 comprises, in particular, the nodes 6 and the factors 7. The nodes 6 include, for example, ego position nodes 11 and landmark nodes 12. The factors 7 include, for example, ego position factors 13, landmark factors 14, and, in particular, map matching factors 15. In particular, the ego position factors 13 link the ego position nodes 11 to one another. In particular, the landmark factors 14 link the ego position nodes 11 to landmark nodes 12. The map matching factors 15 are optionally linked to the ego position nodes 11, which represent a position of the vehicle detected by means of a GNSS system of the detection system 2.

Moreover, the extended factor graph 10 comprises the further nodes 8 and the further factors 9. The further nodes 8 comprise, for example, analogously to the basic factor graph 5, further ego position nodes 16 and further landmark nodes 17. The further factors 9 comprise, in particular, analogously to the basic factor graph 5, further ego position factors 18, further landmark factors 19, and, if applicable, further map matching factors 20.

In the factor graph 10 represented by way of example in FIG. 2, the nodes 12a and the further nodes 17a may, if applicable, be identified. The landmark node 17 is remote from a neighboring node, for example the node 12b, by more than a specified distance, for example. Therefore, it is recognized, in particular, that the node 12b and the further node 17a do not match. Optionally, the distance between the node 12b and the further node 17a exceeds a further maximum distance, such that the further node 17a is identified as inserted and, in particular, not as shifted. If applicable, it is checked for all landmark nodes 12 of the basic factor graph 5 whether a matching and/or shifted further landmark node 17 can be found in each case. For example, no matching or shifted further landmark node 17 can be found for the node 12a of the basic factor graph 5. Therefore, the node 12a is, if applicable, also identified. In particular, the node 12a is marked as deleted and the further node 17a is marked as inserted.

A global map is for example generated on the basis of the extended factor graph 10. For example, mapping objects that are represented by nodes marked as deleted, for example the node 12a, are not shown in the digital map. If the node 12a detected as deleted is identified as visible again when the method is carried out again, it is possible to reuse information about the node 12a of the original basic factor graph 5.

Mapping objects which are represented by nodes marked as inserted are, in particular, inserted in the digital map. Optionally, a digital predecessor map that is based on the basic factor graph 5 is provided. If applicable, the predecessor map is updated on the basis of the extended factor graph 10.

In some embodiments, the following steps, in particular, can be performed, for example as soon as single-trip data, which can also be referred to as a maplet, are provided, in particular at an evaluation circuit:
Checking whether there is already a maplet for particular surroundings, in particular a parking area, for example determinable from an available NDS map using GNSS coordinates.
If this is not the case, a basic factor graph is generated from the ego motion data and mapping object observations.
If this is the case, new nodes are inserted into the factor graph available for the location from the ego motion data and mapping object observations.
The change detection algorithm is executed on the basis of the factor graph. Here, observation nodes which have changed over time, in particular have been inserted, deleted, or shifted, are marked by means of clustering/neighborhood search of observation nodes in spatial proximity.
The graph-based SLAM method is carried out on the basis of the annotated factor graph. Here, the temporal markings are taken into account during the data association step.
The result is saved as a global map. The mapping objects that are marked as deleted are removed from the map. The entirety of the ego motion data modified during the SLAM method are used as the basis for generating the road network, for example waypoint clustering, links, lanes, and trajectories.
The new global map is, if applicable, compared with the predecessor version and deviations therefrom are analyzed. Heuristic completeness rules are applied. If both deviations and completeness rules allow it, the map is approved from the point of view of the backend mapping algorithms. Alternatively or additionally, a human user can perform a visual review and then approve the map for download in vehicles. Another possible option is to approve incomplete global maps or global maps that have not yet converged sufficiently in order to gain time in terms of the availability of the using client function, which is possible, for example, depending on the security level of the client function.

### LIST OF REFERENCE NUMERALS

1 Mapping system
2 Detection system
3 Evaluation circuit
4 Memory
5 Basic factor graph
6 Nodes
7 Factors
8 Further nodes
9 Further factors
10 Factor graph
11 Ego position nodes
12 Landmark nodes
12a Node
12b Node
13 Ego position factors
14 Landmark factors
15 Map matching factors
16 Further ego position nodes
17 Further landmark nodes
17a Node
18 Further ego position factors
19 Further landmark factors
20 Map matching factors

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the function of several items recited in the claims.

The term “exemplary” used throughout the specification means “serving as an example, instance, or exemplification” and does not mean “preferred” or “having advantages” over other embodiments. The term “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1. A method for creating a digital map of surroundings of a vehicle using a mapping system, comprising:
providing a basic factor graph, comprising nodes and factors that were created on the basis of single-trip data from a previous trip;
providing further single-trip data relating to a further trip of a vehicle that is different from the previous trip;
extending the basic factor graph by generating further nodes and further factors and inserting the further nodes and further factors into the basic factor graph on the basis of the provided further single-trip data, such that an extended factor graph is generated by extending the basic factor graph;
identifying nodes of the further nodes which have changed by more than a specified deviation in comparison to the nodes of the provided basic factor graph; and
creating a digital map on the basis of the extended factor graph in consideration of the identified nodes.

2. The method of claim 1, wherein the provided basic factor graph comprises ego position nodes and landmark nodes of detected landmarks in the surroundings of the vehicle as nodes and the provided basic factor graph comprises landmark factors and ego position factors as factors, wherein ego position nodes represent positions to which the vehicle has traveled and landmark nodes represent detected landmarks, wherein ego position factors indicate a spatial relationship between ego position nodes and landmark factors indicate a spatial relationship between ego position nodes and landmark nodes.

3. The method of claim 2, wherein landmark nodes of the further nodes are compared with landmark nodes of the nodes of the provided basic factor graph in order to identify the nodes.

4. The method of claim 1, wherein a change detection algorithm is executed for identifying the nodes, which algorithm determines distances between the nodes and the further nodes using the factors and the further factors.

5. The method of claim 1, wherein identified nodes are marked as inserted, deleted, or shifted.

6. The method of claim 1, wherein each node and each further node comprises a time stamp.

7. The method of claim 1, wherein a road network is generated depending on the further single-trip data and inserted into the generated map.

8. The method of claim 1, wherein a digital predecessor map is provided based on the provided basic factor graph and the digital predecessor map is updated on the basis of the extended factor graph in consideration of the identified nodes.

9. The method of claim 8, wherein the updated digital map is compared with the digital predecessor map and the digital map is changed on the basis of this comparison.

10. A mapping system for creating a digital map, comprising a detection system, a memory, and an evaluation circuit, wherein:
the evaluation circuit is configured to obtain a basic factor graph, comprising nodes and factors generated on the basis of single-trip data from a previous trip;
the detection system is configured to record further single-trip data relating to a further trip of a vehicle that is different from the previous trip and to provide said data to the evaluation circuit;
the evaluation circuit is configured to extend the basic factor graph by generating further nodes and further factors and inserting the further nodes and further factors into the basic factor graph on the basis of the provided further single-trip data, such that an extended factor graph is generated by extending the basic factor graph;
the evaluation circuit is configured to identify nodes of the further nodes which have changed by more than a specified deviation in comparison to the nodes of the provided basic factor graph;
the evaluation circuit is configured to create a digital map on the basis of the extended factor graph in consideration of the identified nodes.

11. The mapping system of claim 10, wherein the provided basic factor graph comprises ego position nodes and landmark nodes of detected landmarks in the surroundings of the vehicle as nodes and the provided basic factor graph comprises landmark factors and ego position factors as factors, wherein ego position nodes represent positions to which the vehicle has traveled and landmark nodes represent detected landmarks, wherein ego position factors indicate a spatial relationship between ego position nodes and landmark factors indicate a spatial relationship between ego position nodes and landmark nodes.

12. The mapping system of claim 11, wherein landmark nodes of the further nodes are compared with landmark nodes of the nodes of the provided basic factor graph in order to identify the nodes.

13. The mapping system of claim 10, wherein a change detection algorithm is executed for identifying the nodes, which algorithm determines distances between the nodes and the further nodes using the factors and the further factors.

14. The mapping system of claim 10, wherein identified nodes are marked as inserted, deleted, or shifted.

15. The mapping system of claim 10, wherein each node and each further node comprises a time stamp.

16. The mapping system of claim 10, wherein a road network is generated depending on the further single-trip data and inserted into the generated map.

17. The mapping system of claim 10, wherein a digital predecessor map is provided based on the provided basic factor graph and the digital predecessor map is updated on the basis of the extended factor graph in consideration of the identified nodes.

18. The mapping system of claim 17, wherein the updated digital map is compared with the digital predecessor map and the digital map is changed on the basis of this comparison.

19. The method of claim 2, wherein a change detection algorithm is executed for identifying the nodes, which algorithm determines distances between the nodes and the further nodes using the factors and the further factors.

20. The method of claim 3, wherein a change detection algorithm is executed for identifying the nodes, which algorithm determines distances between the nodes and the further nodes using the factors and the further factors.
